(19) United States
(12) Patent Application Publication
(10) Pub. No.: US 2010/0153167 A1
(43) Pub. Date: Jun. 17, 2010

(54) INCORPORATING WORKFLOW PROCESS MODIFICATIONS

(75) Inventors: Klaus Kretzschmar, Angelbachtal (DE); Nobuyoshi Mori, Lorsch (DE)

Correspondence Address: SCHWEGMAN, LUNDBERG & WOESSNER/SAP, P.O. BOX 2938, MINNEAPOLIS, MN, 55402, US

(73) Assignee: SAP AG, Walldorf (DE)

(21) Appl. No.: 12/335,718

(22) Filed: Dec. 16, 2008

(51) Int. Cl. G06Q 10/00; G06F 17/30

(52) U.S. Cl. 705/9; 705/8

(57) ABSTRACT

Apparatus, systems, and methods are disclosed that operate to create and access electronic content comprising document files that comprise workflow definitions having information about a plurality of activities in the workflow process chain, including prior activities, the current activity, and subsequent activities. Such documents also contain instructions as part of the workflow definition which, when executed, cause modifications to the workflow definition to be recorded in the document file. Execution of the instructions may also result in identifying a subsequent processing entity to process the document file during subsequent activities in the workflow process chain, based on the embedded information. Additional apparatus, systems, and methods are disclosed.

### BACKGROUND

A workflow process may comprise a number of logical activities executed by a workflow participant and/or machine resources. Increasing the automation of workflow activities can increase efficiency, such as when there is automated delivery of work to the participants, automated tracking of workflow status, and automation of the work itself.

In some cases, processes that involve a high level of participant interaction produce a large amount of unstructured information, reducing the benefits of automating the process. For example, this often occurs within collaborative business processes that make extensive use of editable forms. As they pass through the hands of various participants, the forms may be copied, changed into other formats, and even modified outside the confines of the defined workflow, so that the integrity of the original document may be compromised, and time is lost in locating the most up-to-date version.

### BRIEF DESCRIPTION OF THE DRAWINGS

FIG. 1 illustrates a workflow process that incorporates modifications according to various embodiments of the invention.

FIG. 2 illustrates a document comprising a workflow definition that includes information of various types, according to various embodiments of the invention.

FIG. 3 is a block diagram of a system to implement packaged workflow document processing according to various embodiments of the invention.

FIG. 4 is a flow diagram illustrating methods for initial creation of a packaged workflow document according to various embodiments of the invention.

FIG. 5 is a flow diagram illustrating methods of packaged workflow document processing according to various embodiments of the invention.

FIG. 6 is a block diagram of a machine in the example form of a computer system according to various embodiments of the invention.

### DETAILED DESCRIPTION

To accommodate workflows that contain structured and unstructured data, documents can be created that include instructions which, when executed, provide a structure that has embedded knowledge as to where the document originated, which part of the process it has undergone, what part of the process it currently inhabits, the next part of the process, and how to merge incorporated data into the workflow management system.

The instructions may take the form of an extensible Markup Language (XML) workflow definition, perhaps conforming to the XML-based Process Definition Language (XPDL) format. As is well-known to those of ordinary skill in the art, XPDL defines an XML schema for specifying the declarative part of workflow process chain of activities. In various embodiments, deviations from the workflow definition can be separately recorded in a change log as modifications, perhaps in the form of a Service Data Object (SDO) data change log that is also embedded in the document.

In this way, the process can be brought to the workflow participant, and not the other way around. The workflow process can then be driven by intelligent documents, so that data and process integrity are preserved, even when modifications to the defined workflow process occur.

As an example, consider a group of participants processing their work tasks according to a predefined workflow managed by a workflow management system. The workflow management system supports user interface UI) technologies, such as web forms (e.g., web browser) and rich clients. In offline scenarios, such as when a connection to the company network is not available, the UI should continue to support processing the work tasks.

To make this happen as a natural part of the workflow process, the Office Open eXtensible Markup Language (OOXML) can be used to create documents that accommodate embedding XML files, creating offline UI technology. If information about the workflow itself is made available offline in this manner (e.g., by embedding the information in an OOXML-based document), participants can proceed to work according to the workflow without access to the network-coupled workflow management engine. For example, XML language may be embedded in a document to specify that if the participant is taking part in the activity “Check Invoice Quantities”, then the next processor will be “Accounting”. Thus, even if network connectivity is lost during the activity of “Check Invoice”, the integrity of the workflow process can be preserved by sending the document on to “Accounting” after the “Check Invoice Quantities” activity is complete.

In some embodiments, application programs (e.g., Microsoft Office® applications, such as Microsoft PowerPoint®) can be enhanced to enable the application to read and process the workflow definition XML file embedded in its respective documents. For example, the enhancement can be accomplished by using Net Office Add-In technology to create a plug-in to the application. In this way, the OOXML-based document can maintain a snapshot of the current workflow process state. Programs that can be used to produce such plug-ins are well-known to those of ordinary skill in the art, and include Add-in Express™ for VSTO as an extension of Microsoft® Visual Studio Tools for Office, designed to create application-level add-ins for Microsoft Outlook®, Microsoft Excel®, Microsoft Word, Microsoft PowerPoint®, Microsoft InfoPath®, and Microsoft Visio®.

It should be noted that while use of XML, XPDL, and OOXML have been described herein by way of example, the various embodiments described are not to be so limited. Any language, language format, and/or set of instructions that can be used to describe a workflow process chain of activities can be used to form a document and/or application document as they are described herein.

For the purposes of this document, a “document application” means the combination of a workflow definition-based document and an application enhanced by a plug-in used to read and process workflow definition files embedded in the workflow definition-based document.

“Electronic content” includes any digital data that may be presented to a workflow participant (e.g., visually or audibly presented), such as an electronic document, page-descriptive electronic content such as a page-descriptive electronic document, media stream, web page, hypertext document, image, digital video or video recording, digital audio or audio recording, an animation, a markup language document, such as for example a document including HyperText Markup Language (HTML) or XML, a form having components to be filled in, or data describing the application of a graphical user interface (GUI). Electronic content may comprise a variety of content elements.

A “content element” includes any part or share of electronic content that is defined or discernable as a part or share. For example, a content element may be automatically discerned from a characteristic of the content element itself (e.g., a paragraph of an electronic document, or a file format designation) or may be manually defined by a workflow participant (e.g., a user-selected collection of words in an electronic document, a user-selected portion of a digital image). Examples of content elements include portions of a page-descriptive document or other electronic document, such as, for example, pieces of electronic text or other material, such as a group of instructions within the electronic document, dynamic content in the form of portions of media streams such as sections of digital video or frames or sets of frames of digital video or digital audio, dynamic content in the form of segments or frames of animations, electronic forms, form templates, form elements, form data, actuatable element specifications or executable instructions, and various elements presentable or accessible by workflow participants within electronic content, including instances of scripted and non-scripted dynamic content and the like.

Certain applications or processes are described herein as including a number of modules. A “module” is a unit of distinct functionality that can provide information to, and receive information from, other modules. Accordingly, the described modules may be regarded as being communicatively coupled. Modules may also initiate communication with input or output devices, and can operate on a resource (e.g., a collection of information). Modules may include hardware circuitry, optical components, single or multi-processor circuits, memory circuits, software program modules and objects, firmware, and combinations thereof, as appropriate for particular implementations of various embodiments. The term “module” may include an identifiable portion of code, data, or computational object, such as a document application, designed to achieve a particular function, operation, processing, or procedure.

“Outside information” is information received from activities that occur outside of a workflow process definition. In various embodiments, such information can be recorded in a document or document application, perhaps in the form of modifications listed in an XML-based change log file.

A “plug-in” is a run-time application engine that is used to process workflow activities on the client side, apart from a workflow management engine operative on a server or network.

A “resource” comprises a web page, a file on a disk, or any manifestation of information inside a computer system. Other examples of resources include address book items, database entries, and calendar appointments.

A “workflow definition” operates to define data flow and control flow between each of the plurality of activities in a chain of workflow process activities.

In most embodiments, documents are integrated into the workflow process chain of activities in a substantially seamless manner. Process consistency between the activities is maintained by tracking the current activity within the chain, as well as the next processor in the chain, using the document itself.

In prior implementations of workflow process management, a database management system may have been used to maintain the workflow definition, so that documents processed in any way that was disconnected from the base system were not integrated back into the system, and thus, lost integrity. As a matter of contrast, in some embodiments, XML files are embedded in a workflow definition-based document, such as an OOXML-based document that includes a workflow definition, so that a wide variety of non-visual information can be included as part of the document itself, perhaps as meta-data.

In some cases, a portion of this meta-data can be constructed as a plug-in to an application, such as a word processing application. The application, along with the plug-in, can serve as the workflow processing engine. The meta-data also comprises information and instructions that can be used to form the workflow definition.

Unlike application macros that serve to automate standard application functionality, the plug-in can execute any set of instructions that are embedded in the document. For example, the plug-in can operate to read the workflow description and locate the next processor in the workflow process chain of activities. In this way, the entire workflow process can be described in the workflow definition that is included in the document, so that each processor can be identified, as well as the branches, data, and even control flow between applications. In this way, participants can engage in the workflow process without having access to the workflow management system.

Deviations from the original workflow process definition are also accommodated using information that is embedded in the document. For example, the embedded workflow process definition may operate to designate participant B to operate on the document after participant A has finished. However, participant A may determine that it would be wise to gather feedback from participant Z prior to sending the document on to participant B, even though this modification was not considered as part of the original workflow process definition. Fortunately, in most embodiments, this kind of ad-hoc change to the process can be recorded as part of a change log in the document, perhaps providing a basis for future process improvement. When participants reconnect to the workflow management system, such as a back-end server process, analyses of the change log included in the document can be conducted, so that the recorded deviations, in the form of modifications to the process, can be used in turn to redefine the process, if desired. Some example embodiments that incorporate these mechanisms will now be described in more detail.

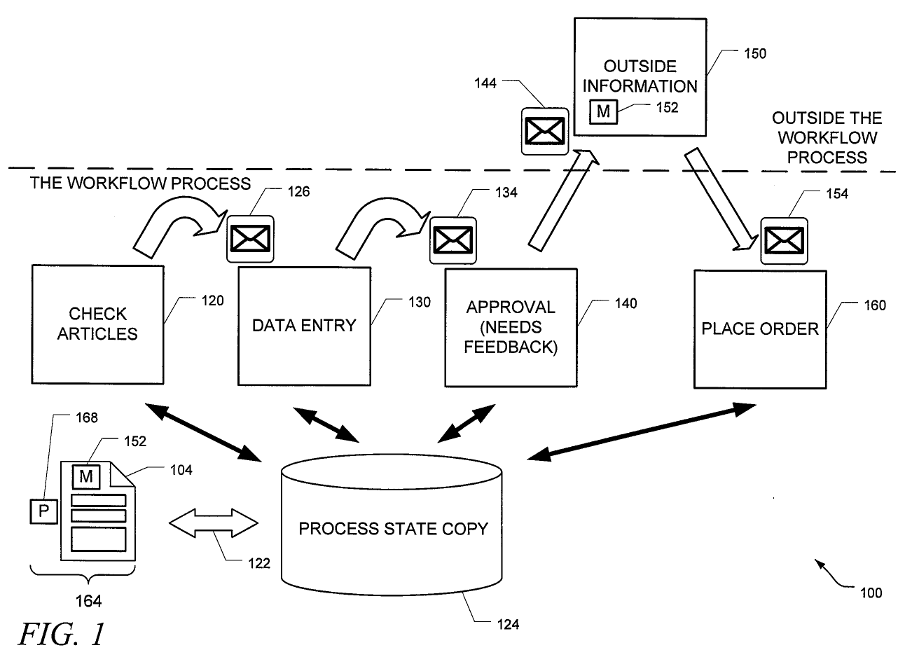

FIG. 1 illustrates a workflow process 100 that incorporates modifications 152 according to various embodiments of the invention. For example, consider a company that operates to monitor stocking levels of articles carried by drug stores. The operations include determining what each drug store should order next to maintain full coverage of all articles they sell.

To begin, during activity 120, the service manager at the company receives notice from the company workflow management system that the stocking levels for particular articles are low at one of their customer stores, and that the customer desires to order additional articles to replenish the supply. The service manager then triggers the workflow management system to initiate an inventory replenishment workflow process 100.

As part of activity 122, the workflow management system 124 operates to create an OOXML-based Microsoft® Word document 104 containing a workflow definition that includes a snapshot copy of the workflow process state, and sends the document 104 with a formatted list of articles that should be ordered to the customer via e-mail as part of activity 126.

As part of activity 130, data describing the quantity of articles to be ordered is received and recorded in a form provided by the document 104, perhaps using an article entry stocking terminal client running the Microsoft® Word application. The information regarding the current activity in the workflow process chain of activities is also updated and recorded in the document 104.

In activity 134, the document 104, including the data describing articles to be ordered, as well as the current activity in the workflow process chain, is sent to an approval entity (e.g., the purchasing manager of the order entry clerk that specified the number of articles to be ordered during activity 130), which is the next processor in the workflow process chain. Since the OOXML-based document 104 contains information about all of the activities in the article replenishment workflow process 100, the document 104 can be sent directly to the next processor after receiving an indication that data entry is complete, as part of activity 130. For example, upon being notified that a “submit” widget associated with the document 104 has been activated, an email message that includes the address of the next processor, with the document 104 attached, can be automatically created and sent to the next processor.

In activity 140, the purchasing manager is tasked with approving the content of the order, as it has been recorded in the document 104. Upon receiving the email message delivered to him as part of activity 134, the purchasing manager opens the attached document 104, which may comprise an OOXML-based form. In this case, the document 104 is processed by a Microsoft® Word application plug-in program, causing the internal workflow state to advance to the next activity (activity 140), operating to unlock only those input fields which are relevant for the purchasing manager (e.g., signature field) to edit. All other input fields are locked.

In this case, the purchasing manager notices that some of the quantities are larger than he has ever approved before, and he is unsure about whether to approve the order. Although he is inclined to consult with his supervisor (e.g., the purchasing director) as part of activity 150, this action is not part of the workflow process definition that is originally included in the document 104.

To deal with this situation, the purchasing manager determines that it is possible to send an email message and the document 104 outside the process 100 by changing the email address of the next processor (e.g., the purchasing clerk that participates in the process 100 as part of activity 160). When activities 144, 150, 154 occur outside the process 100, process integrity and consistency are preserved by recording any deviations to the defined process flow as modification 152 in a file, such as a separate XML log file. This change log file records information received from outside the process 100, and can be embedded in the document 104, perhaps as meta-data.

Thus, the purchasing manager can send the document 104 via email to the purchasing director as part of activity 144, and the purchasing director can approve the order with her signature in place of the purchasing manager's as part of activity 150. The purchasing director can then send the document 104, including the modifications 152, via email on to the purchasing clerk as part of activity 154. In this case, the modifications 152 comprise at least the email address and signature of the purchasing director. Post-process analysis of the change log may be used to incorporate optional approval by the purchasing director in future definitions of the process 100, as desired (e.g., when specified quantities of particular articles are exceeded).

After receiving the approved order during activity 160, the order can be placed. This can be accomplished by the purchasing clerk activating a “Place Order” widget, which results in the approved order, in the form of the document 104, being sent back to the company so that the articles on order can be prepared for delivery. Further activities in the process 100 can be triggered by reception of the document 100 in the workflow management system of the company, perhaps by analyzing the information received from the customer, including that which is contained in the change log. The received information and change log information can be rendered on a display screen as part of a GUI.

The document 104 upon which the process 100 operates is unique. Copies of the document 104 are not made as part of the process 100, and if such copies are made outside of the process 100, such actions constitute modifications 152 which are recorded in the document 104. Thus, as the document 104 progresses through the workflow process 100, the information in the document 104 regarding the current activity of the process 100, prior and subsequent activities, the active (unlocked) fields, and operative applications is constantly updated according to the particular process activity that is in effect.

The document 104 may take the form of a Microsoft® Word file or portable document format (*.pdf) file that has one or more embedded XML files, a Microsoft® PowerPoint presentation file, or Microsoft® Visio drawing files. The document 104 may include a snapshot of the current state of the process 100, perhaps in the XPDL format, which can be used as a standard for communication between workflow engine processors.

The plug-in 168 serves as a supervisory control program that monitors the interaction between all of the contents in the document 104, maintains consistency against data types in the data entry while fields are locked and unlocked, and has knowledge of the next activity in the process 100. The plug-in 168 to the active application controls functions of the application according to the process activity in effect as well. Thus, modification of information included in the document is controlled to some degree by the active plug-in 168. In some embodiments, the plug-in 168 comprises a complete workflow process management engine, so that the document 104 and plug-in combine to form a document application 164 that is self-contained, and the workflow process can be maintained entirely by the plug-in 168, without the use of a separate workflow management engine, or connection to any network.

On the other hand, as mentioned previously, the document 104 may be sent to the workflow management system 124 at various intervals, so that the information and modifications 152 that form a part thereof can be assimilated into the workflow definition contained in the document 104. For example, analyses of the change log included in the document 104 can be conducted, so that the recorded deviations, in the form of modifications 152 to the process 100, can be used in turn to redefine the process 100.

Thus, in some embodiments, the document 104 can be received, monitored, updated, and transmitted as part of operations conducted by the workflow management system 124 as it moves in and out of the defined process 100. In this way, the document 104 can cooperate with a conventional workflow management system to monitor and control the process 100, and the operations of the conventional workflow management system itself can become part of the workflow process definition.

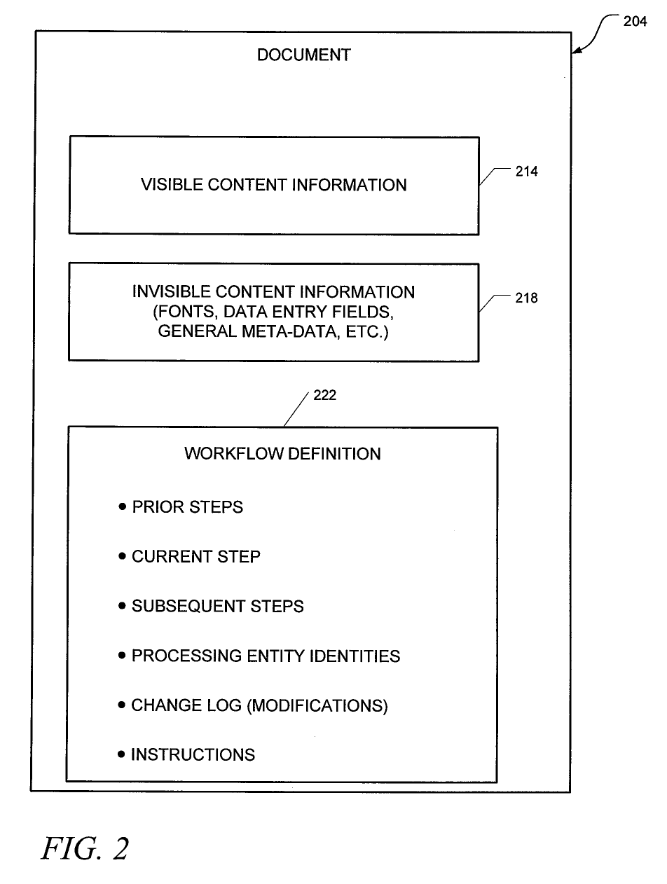

FIG. 2 illustrates a document 204 comprising a workflow definition 222 that includes information of various types, according to various embodiments of the invention. The document 204 may be similar to or identical to the document 104 of FIG. 1. Turning now to FIG. 2, it can be seen that the document 204 comprises visible content information 214, invisible content information 218, and one or more workflow definitions 222.

The visible content 214 comprises text, images, video clips, and other content elements that are meant to be visible to workflow process participants that view the document as it is rendered in a display screen. The invisible content information 218 comprises content elements that are not seen by the workflow process participants, and that influence the way in which the visible content information 214 is rendered. For example, the invisible content information 218 may comprise formatting information, font information, style information, general meta-data (e.g., creator identity, creation date, version), etc.

The workflow definition 222 comprises a description of a plurality of activities in the workflow process, such as prior activities, the current activity, and subsequent activities. The definition 222 may also include processing entity identities (e.g., terminals, clients, servers, workflow management systems, personnel, etc.) for each activity, a change log (which contains modifications to the workflow definition 222), and instructions to guide the processing of the document 204, such as instructions which, when executed by the associated plug-in, cause certain fields in the document 204 to be locked or unlocked, or an email message to be generated, addressed to the next processor in the workflow process. The document 204 may include further information, included executable instructions or non-executable data, as desired.

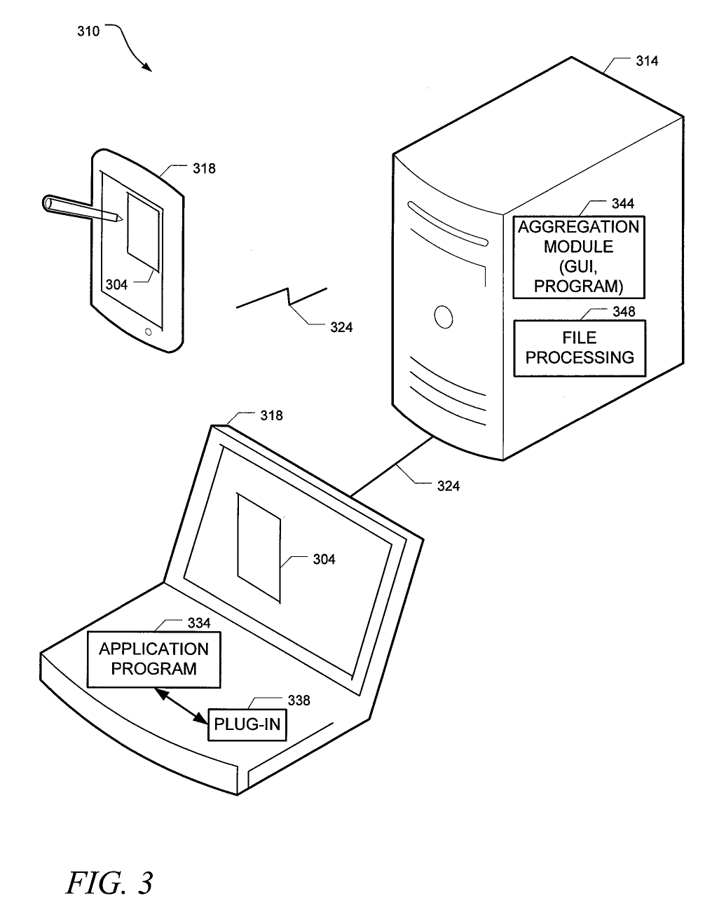

FIG. 3 is a block diagram of a system 310 to implement packaged workflow document processing according to various embodiments of the invention. The system 310 implements a workflow management system using a networked enterprise server 314. Participants in the workflow process can engage in the workflow by editing OOXML-based documents 304 offline using a disconnected service oriented architecture (SOA). The documents 304 may be similar to or identical to the documents 104, 204 of FIGS. 1 and 2, respectively.

Several different technologies may be included in the system 310. For example, the system 310, as part of a larger workflow process management system may have the capability to define and process arbitrary business workflow processes, as well as to support OOXML-based documents 304 as UI technology during the execution of various activities.

The system 310 may thus include a server 314 and one or more clients 318. The server 314 may include several modules, including an aggregation module 344 and a file processing module 348. The aggregation module 344 can be used to receive identification information for a document 304 file, and a workflow definition that includes information about a plurality of activities in the workflow process chain, including prior activities, the current activity, and subsequent activities. That is, the workflow definition may include information about all activities, including the current activity/state, in the workflow process chain. The file processing module 348 can be used to associate some or all of the workflow definition with the file that identifies the document 304. The associated portion of the workflow definition includes instructions which, when executed, result in recording modifications to the workflow definition in the document file, and in identifying a subsequent processing entity to process the document file during subsequent activity in the workflow process chain.

Thus, document 304 may include OOXML embedded meta-data formatted as XML files, perhaps comprising a workflow definition in XPDL. Document 304 may also include a high-level description of activities and control flow, a description of expected and returned data in each activity, a description of all external data references (e.g., web services, data bases, etc.), and a change log (e.g. an SDO change log), which may also be rendered in XML, to describe all modifications to the original workflow definition.

Finally, the system 310 may include a plug-in 338 to client application programs 334, perhaps taking the form of a .Net Office Add-In program. The plug-in 338 may operate as a run-time engine to control processing of workflow activities on the side of the client 318, rather than the server 314, even when the client 318 is disconnected from the wired or wireless network 324 that couples the client 318 to the server 314. Thus, many embodiments may be realized.

For example, a system 310 may comprise a processor-implemented aggregation module 344 to receive identification of a document file and a workflow definition, and a processor-implemented file processing module 348 to associate at least part of the workflow definition with the document file. The processor-implemented aggregation module 344 may comprise one or more of a GUI module or an executable file processing program module, either of which may be used to gather information about the workflow process definition and the document file. The information may be gathered using manual input from the GUI, or automatically, using the executable program file, of some combination of these. Thus, for example, the aggregation module 344 may be used to aggregate business data to appear in a document/form, and the file processing module 348 can be used to perform business data merge/extraction operations on the document/form.

Both servers and clients can be used in many different ways within the system 310. For example, servers 314 or clients 318 can be used to house the aggregation module 344 and/or the file processing module 348. In some embodiments, the client 318 includes application programs 334 and plug-ins 338 to the application programs 334, where the plug-in 338 is used to execute the instructions embedded in the documents 304. Still further embodiments may be realized. Some of these include a variety of methods.

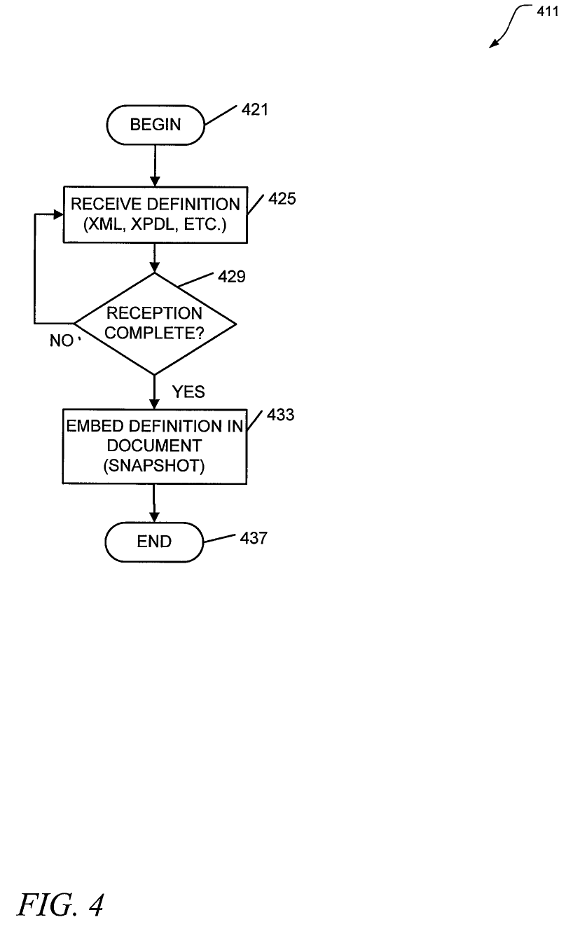

For example, FIG. 4 is a flow diagram illustrating methods 411 for initial creation of a packaged workflow document according to various embodiments of the invention. The methods 411 are implemented in a machine-accessible and readable medium, and are operational over processes within and among networks. The networks may be wired, wireless, or a combination of wired and wireless. The methods 411 may be implemented as instructions, which when accessed by a machine, perform the processing depicted and described with respect to the elements and processes shown in FIGS. 1-3. Given this context, the initial creation of a packaged workflow document that incorporates workflow process modifications into a defined chain of workflow process activities is now discussed with reference to FIG. 4.

In some embodiments, a computer-implemented method 411 of creating a packaged workflow document may begin at block 421, and continue on to block 425 with receiving a workflow definition. Workflow definitions can be developed in many ways, such as by using software applications similar to or identical to the SAP® WebFlow® engine available from SAP AG of Walldorf, Germany. The received definition may include information about a plurality of activities in a workflow process chain, such as prior activities, the current activity, and subsequent activities.

The definition that is received may also contain information that includes, for example, the identity of the processors for each activity (including a workflow management system, if desired), contact information for the processors, the identification of data to be received and presented during each activity, etc. The activity at block 425 may comprise receiving at least some of the workflow definition in an XML format, including the XPDL format. For example, the workflow definition may be received from a web service, perhaps as part of an SOA architecture.

The method 411 may continue on to block 429, where a determination is made as to whether reception of the workflow definition is complete. If not, the method 411 returns to block 425 to continue reception.

If it is determined that reception of the workflow definition is complete, then the method 411 may continue on to block 433 with embedding at least part of the workflow definition within electronic content comprising a document file. The embedded portion of the workflow definition may comprise instructions which, when executed, result in identifying a subsequent processing entity to process the document file during one or more subsequent activities in the workflow process chain. Executing the embedded instructions may also result in recording modifications to the workflow process chain in the document file during process execution.

For example, the activity of embedding the definition in the document at block 433 may include embedding a snapshot of the current state of the workflow definition, including the modifications, in the document file. The document file itself may comprise any type of document file, including a word processor document file, a spreadsheet document file, a database document file, a presentation document file, and/or drawing document files, among others. The document file may also be formatted according to any number of formats and standards, such as OOXML, or the Open Document Format (ODF). The method 411 may terminate at block 437.

Thus, in many embodiments, a packaged workflow document can be created by receiving a workflow definition and associating the definition with a document, so that instructions in the definition can be executed to determine the identity of the next processor that operates within the context of the next workflow process activity. Any number of activities in the workflow process chain, including all subsequent activities, can be included in the workflow definition.

The instructions included in the document can be quite extensive. For example, in some embodiments, the instructions, when executed, comprise a workflow processing engine to execute activities according to the workflow definition and to record the modifications to the workflow process. That is, the number and type of instructions may be of any complexity, including instructions sufficient to implement a complete workflow processing engine.

In this way, the instructions in the workflow definition may include operations which control data entry, and identify subsequent processing entities to receive the document. For example, the instructions, when executed, may operate to lock fields in the document file against data entry, receive data to enter into document file fields, and present the identity of subsequent processing entities to a participant that views content included in the document file.

As noted previously, modifications to the workflow process can be recorded in a change log forming part of the information in the document. The change log may be expressed in XML format. Many other embodiments may be realized.

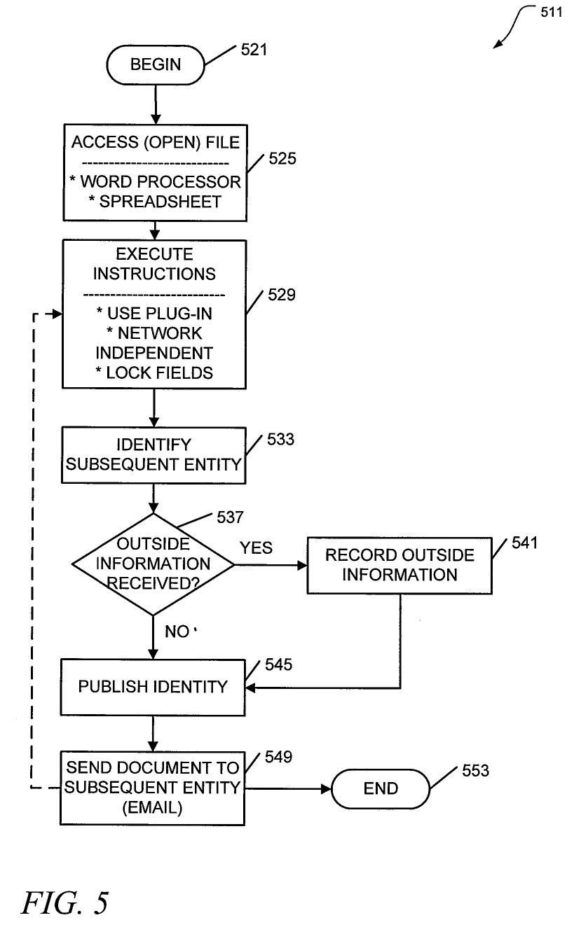

For example, FIG. 5 is a flow diagram illustrating methods 511 of packaged workflow document processing according to various embodiments of the invention. The methods 511 are implemented in a machine-accessible and readable medium, and are operational over processes within and among networks. The networks may be wired, wireless, or a combination of wired and wireless. The methods 511 may be implemented as instructions, which when accessed by a machine, perform the processing depicted and described with respect to the elements and activities of FIGS. 1-4. Given this context, incorporating workflow process modifications into a defined chain of workflow process activities with respect to a document comprising a packaged workflow is now discussed with reference to FIG. 5.

In some embodiments, a computer-implemented method 511 of processing a document that comprises a packaged workflow may begin at block 521 and continue on to block 525 with accessing electronic content comprising a document file including a workflow definition. The electronic content may be accessed by opening a document file using any number of applications. Such applications include word processors, spreadsheet processors, presentation processors, database processors, and drawing processors, among others. Thus, the activity in block 525 may comprise opening the document file using a word processing application and/or a spreadsheet processing application, for example.

The method 511 may go on to block 529 with executing instructions included in the workflow definition to execute activities according to the workflow definition and to record modifications to the workflow definition in the document file. The embedded instructions may be executed by a plug-in to the basic document processing application, as described previously. Thus, the activity at block 529 may comprise executing the instructions using a plug-in application to a document processing application.

In this way, the embedded instructions that define the workflow process chain of activities can be executed without being connected to a network. Thus, the activity at block 529 may also include executing the instructions independently of coupling the current processing entity to a network.

Execution of the instructions may result in any number of actions. For example, the activity of block 529 may comprise selectively locking some fields against data entry by the current processing entity based on the information in the workflow definition. This might occur, for example, when only approval is needed, and no document data is to be modified. Thus, fields can be locked/unlocked as needed to receive new or revised data from the appropriate processing entity.

The instructions may comprise meta-data included (e.g., embedded) in the document file. In this way, some portion of the document file content can be displayed to a workflow participant, and data can be entered according to what is permitted by executing the embedded instructions. Thus, the activity at block 529 may also include rendering content in the document file to a workflow participant viewing the content as part of a GUI, and receiving data for entry into document fields as permitted by the execution of the instructions.

The method 511 may continue on to block 533 to include identifying a subsequent processing entity to process the document file during subsequent activity in the workflow process chain, based on the information in the document file. In some embodiments, the subsequent processing entity comprises a conventional workflow management system, similar to or identical to the SAP® Business Workflow products available from SAP AG of Walldorf, Germany, including the SAP® WebFlow® engine.

The method 511 may then continue on to block 537, with determining whether outside information has been received. That is, determining whether information in the form of data, instructions, and other information outside the workflow definition contained in the document file, has been received. If not, the method 511 may continue on to block 545.

Otherwise, the method 511 may comprise receiving outside information from an outside processing entity not included in the workflow definition at block 537, and then go on to block 541 with the activity of recording the outside information and/or a processor identity associated with the outside processing entity as data embedded in the document file. Further activity at block 541 may include identifying outside information added to the workflow definition, and incorporating the outside information into the workflow definition. In this way, information can be received from outside the defined workflow process chain, recorded as part of the document, and made part of the workflow process itself, maintaining the integrity of the process. For example, the subsequent processing entity may comprises a workflow management system to update the workflow definition based on the outside information.

The method 511 may go on to block 545 with publishing the identity of a subsequent processing entity. Publication may include visually indicating an email address of the entity, for example, or simply transmitting identification information to the next activity in the process.

The method may go on to block 549 with sending an email message including the document file to the subsequent processing entity. Thus, the next activity in the workflow process chain can be initiated by sending an email message to the next processor with the document file attached. The method 511 may terminate at block 553, or go on to execute further instructions at block 529.

Those of ordinary skill in the art will realize that each of the method elements shown in FIG. 5 may be added to or substituted for any of the method elements shown in FIG. 4. Additionally, those of ordinary skill in the art will also realize that each of the method elements of FIGS. 4-5 may be combined in a variety of ways, to form a variety of methods that use the elements from each of the figures in serial, parallel, looped, and/or repetitious fashion.

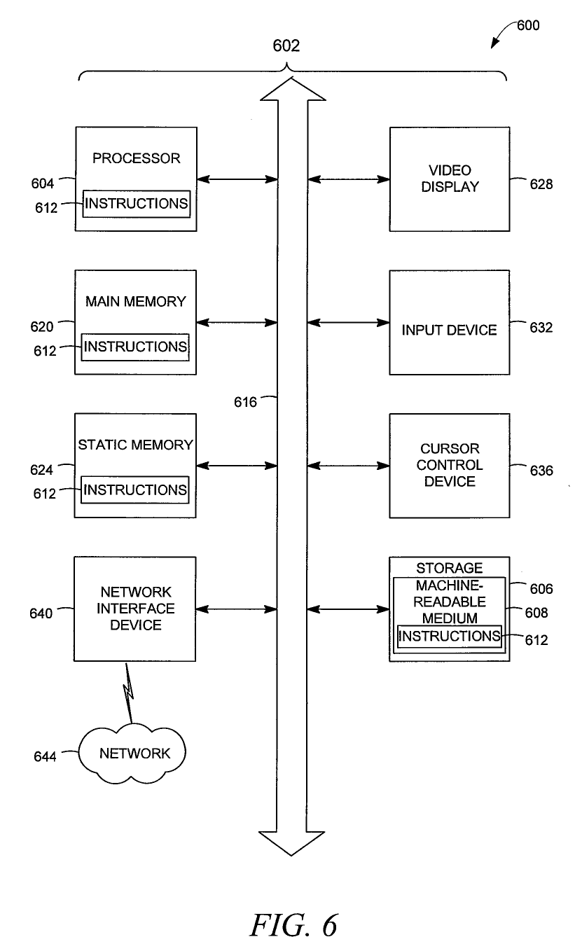

FIG. 6 is a block diagram of a machine 602 in the example form of a computer system 600 according to various embodiments of the invention. The computer system 600 may include a set of instructions 612 for causing the system 600 to perform any one or more of the methodologies discussed herein, including those illustrated in FIGS. 4-5. The system 600 may be similar to or identical to the system 310 of FIG. 3.

In FIG. 6, it can be seen that the components of the machine 602 may include main memory 620, static or non-volatile memory 624, and mass storage 606. Other components coupled to the processor 604 may include an output device 628, such as a video display, an input device 632, such as a keyboard, and a cursor control device 636, such as a mouse. A network interface device 640 to couple the processor 604 and other components to a network 644 may also be coupled to the bus 616.

The processor 604, the memories 620, 624, and the storage device 606 may each include instructions 612 which, when executed, cause the machine 602 to perform any one or more of the methods described herein. The instructions 612 may further be transmitted or received over the network 644 via the network interface device 640 utilizing any one of a number of well-known transfer protocols (e.g., the HyperText Transfer Protocol). Any of these elements coupled to the bus 616 may be absent, present singly, or present in plural numbers, depending on the specific embodiment to be realized.

In some embodiments, the machine 602 operates as a standalone device or may be connected (e.g., networked) to other machines. In a networked environment, the machine 602 may operate in the capacity of a server or a client device in server-client network environment, or as a peer machine in a peer-to-peer (or distributed) network environment. The machine 602 may comprise a personal computer (PC), a tablet PC, a set-top box (STB), a PDA, a cellular telephone, a web appliance, a network router, switch or bridge, or any machine capable of executing a set of instructions (sequential or otherwise) that specify actions to be taken by that machine. Further, while only a single machine 602 is illustrated, the term “machine” shall also be taken to include any collection of machines that individually or jointly execute a set (or multiple sets) of instructions to perform any one or more of the methodologies discussed herein.

While the machine-readable medium 608 is shown as a single medium, the term “machine-readable medium” should be taken to include a single medium or multiple media (e.g., a centralized or distributed database, and/or associated caches and servers, and or a variety of storage media, such as the processor 604 registers, memories 620, 624, and the storage device 606) that store the one or more sets of instructions 612. The term “machine-readable medium” shall also be taken to include any medium that is capable of storing, encoding or carrying a set of instructions for execution by the machine and that cause the machine 602 to perform any one or more of the methodologies of the present invention, or that is capable of storing, encoding or carrying data structures utilized by or associated with such a set of instructions. The terms “machine-readable medium” or “computer-readable medium” shall accordingly be taken to include tangible media, such as solid-state memories and optical and magnetic media.

In conclusion, it can be seen that the workflow processing mechanisms presented herein may provide increased efficiency by incorporating outside information (in the form of modifications introduced by activities that occur outside the original workflow process definition) directly into one or more documents that are processed as part of the workflow. Such documents do not rely on connectivity to a networked workflow process management engine to maintain the integrity of the process. This is because the workflow definition, along with a log of modifications to the workflow process, are carried by the document itself. The results may include increased workflow process efficiency, and more comprehensive process integration capability.

Embodiments of the invention can be implemented in a variety of architectural platforms, operating and server systems, devices, systems, or applications. Any particular architectural layout or implementation presented herein is thus provided for purposes of illustration and comprehension only, and is not intended to limit the various embodiments.

The Abstract of the Disclosure is provided to comply with 37 C.F.R. §1.72(b) and will allow the reader to quickly ascertain the nature of the technical disclosure. It is submitted with the understanding that it will not be used to interpret or limit the scope or meaning of the claims.

In this Detailed Description of various embodiments, a number of features are grouped together in a single embodiment for the purpose of streamlining the disclosure. This method of disclosure is not to be interpreted as an implication that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. A computer-implemented method for initial creation of a packaged workflow document, comprising:
receiving a workflow definition having information about a plurality of activities in a workflow process chain;
embedding at least part of the workflow definition within electronic content comprising a document file, the at least part of the workflow definition including instructions which, when executed, result in identifying a subsequent processing entity to process the document file during at least one subsequent activity in the workflow process chain, and in recording modifications to the workflow process chain in the document file during process execution.

2. The method of claim 1, wherein the instructions, when executed, comprise:
a workflow processing engine to record the modifications.

3. The method of claim 1, wherein the receiving comprises:
receiving at least some of the workflow definition in an extensible Markup Language format.

4. The method of claim 1, wherein the at least part of the workflow definition comprises:
at least one of an identity of a current processing entity, the subsequent processing entity, or an additional activity in the workflow process chain.

5. The method of claim 1, wherein the modifications are recorded in a change log forming part of the information.

6. The method of claim 1, wherein the embedding comprises:
embedding a snapshot of a current state of the workflow definition, including the modifications, in the document file.

7. The method of claim 1, wherein the document file comprises:
at least one of a word processor document file or a spreadsheet document file.

8. The method of claim 1, wherein the document file comprises:
at least one of an Office Open extensible Markup Language file or an Open Document Format file.

9. The method of claim 1, wherein the instructions, when executed, result in at least one of locking a field in the document file against data entry, receiving data to enter into a field in the document file, or presenting an identity of the subsequent processing entity to a workflow participant viewing content included in the data file.

10. A computer-implemented method, comprising:
accessing electronic content comprising a document file including a workflow definition having information about a plurality of activities including at least one prior activity in a workflow process chain, a current activity in the workflow process chain, and at least one subsequent activity in the workflow process chain;
executing instructions included in the workflow definition to record modifications to the workflow definition in the document file; and
identifying a subsequent processing entity, based on the information, to process the document file during the subsequent activity in the workflow process chain.

11. The method of claim 10, wherein the accessing comprises:
opening the document file using at least one of a word processing application and a spreadsheet processing application.

12. The method of claim 10, wherein the executing comprises:
executing the instructions using a plug-in application to a document processing application.

13. The method of claim 10, wherein the executing comprises:
executing the instructions independently of coupling a current processing entity to a network.

14. The method of claim 10, wherein the executing comprises:
selectively locking some fields against data entry by a current processing entity based on the information in the workflow definition.

15. The method of claim 10, further comprising:
receiving outside information from an outside processing entity not included in the workflow definition; and
recording the outside information and a processor identity associated with the outside processing entity as data embedded in the document file.

16. The method of claim 15, wherein the subsequent processing entity comprises a workflow management system to update the workflow definition based on the outside information.

17. The method of claim 10, wherein the instructions comprise:
meta-data included in the document file.

18. The method of claim 10, further comprising:
publishing an identity of the subsequent processing entity.

19. A computer-readable medium having instructions stored therein for causing a computer to implement a method, comprising:
accessing a document file associated with a workflow definition having information about a plurality of activities, including at least one prior activity in a workflow process chain, a current activity in the workflow process chain, and at least one subsequent activity in the workflow process chain; and
executing instructions included in the workflow definition to record modifications to the workflow definition in the document file, and to identify a subsequent processing entity to process the document file during the subsequent activity in the workflow process chain.

20. The medium of claim 19, wherein the method further comprises:
identifying outside information added to the workflow definition; and
incorporating the outside information into the workflow definition.

21. The medium of claim 19, wherein the method further comprises:
rendering content in the document file to a workflow participant as part of a graphical user interface; and
receiving data for entry into document fields as permitted by the executing of the instructions.

22. A system, comprising:
a processor-implemented aggregation module to receive identification of a document file and a workflow definition having information about a plurality of activities, including at least one prior activity in a workflow process chain, a current activity in the workflow process chain, and at least one subsequent activity in the workflow process chain; and
a processor-implemented file processing module to associate at least part of the workflow definition with the document file, the at least part of the workflow definition including instructions which, when executed, result in recording modifications to the workflow definition in the document file, and in identifying a subsequent processing entity to process the document file during the subsequent activity in the workflow process chain.

23. The system of claim 22, wherein the processor-implemented aggregation module comprises:
one of a graphical user interface module or an executable file processing program module.

24. The system of claim 22, further comprising:
a server device including the aggregation module and the file processing module.

25. The system of claim 22, further comprising:
a client device including an application program and a plug-in to the application program, the plug-in to execute the instructions.
